(19) United States
(12) Patent Application Publication
(10) Pub. No.: US 2004/0021287 A1
(43) Pub. Date: Feb. 5, 2004

(54) Suspension unit

(76) Inventor: Sean Timoney, Dublin (IE)

Correspondence Address: BIRCH STEWART KOLASCH & BIRCH, PO BOX 747, FALLS CHURCH, VA, 22040-0747, US

(21) Appl. No.: 10/628,413

(22) Filed: Jul. 29, 2003

(30) Foreign Application Priority Data
Jul. 29, 2002 (IE) S2002/0628`

(51) Int. Cl. B60G 9/04

(52) U.S. Cl. 280/124.158

(57) ABSTRACT

A suspension unit for a leading or trailing suspension arm which carries a vehicle road wheel has a pair of hydrogas units connected to the suspension arm and arranged to resist movement of the suspension arm in opposite directions. The suspension unit of the invention can be used in vehicles which are required to be invertible.

### BACKGROUND OF THE INVENTION

This invention relates to vehicle suspension units, and in particular to hydrogas suspension units.

Vehicle suspension units using a gas such as nitrogen as the spring medium together with an hydraulic fluid to transmit wheel loads and provide the damping medium are sometimes referred to as “hydrogas” suspension units. They have the advantage of a progressive spring characteristic determined by the gas law. Furthermore, this characteristic can be readily adjusted by altering the volume of oil and/or gas in the unit. The amount of damping can also be changed, by changing the damping orifice and blow-off springs.

In certain circumstances it is desirable to have a symmetrical spring characteristic such that the spring has similar characteristics in bounce and rebound. Such a situation arises in the rather unusual case where the suspension is required to function when the vehicle is inverted. Also, it may be required that the static height of the vehicle should be readily adjustable. The present invention is aimed at achieving these requirements.

### SUMMARY OF THE INVENTION

According to the invention there is provided a hydrogas suspension unit for acting on a leading or trailing suspension arm connected between the suspension unit and a vehicle road wheel, the suspension unit including:

a support for mounting on the vehicle,

pivot means for pivotally mounting the suspension arm on the support,

a pair of associated hydrogas units mounted on the support, namely a first hydrogas unit and a second hydrogas unit,

each of said first hydrogas unit and said second hydrogas unit being operably connected to the pivot means to resist pivotal movement of said pivot means in opposite directions.

In one embodiment of the invention each hydrogas unit has a gas cylinder and an associated oil cylinder,

said gas cylinder having a separator piston slidably mounted therein and dividing the gas cylinder into a gas chamber and an oil chamber,

said oil cylinder having a plunger piston slidably mounted within the oil cylinder and defining therewith an oil chamber of variable volume,

the oil chamber of the oil cylinder communicating with the oil chamber of the gas cylinder via a damper which is operable to regulate the flow of oil between the oil cylinder and the gas cylinder,

the plunger piston being connected by a connecting rod to a crankshaft which forms the pivot means,

said crankshaft being rotatably mounted on the support,

said crankshaft having means for connection to the suspension arm,

the connecting rods of the first hydrogas unit and the second hydrogas unit being connected to the crankshaft such that the first hydrogas unit and the second hydrogas unit resist rotation of the crankshaft in opposite directions.

In another embodiment said first and second hydrogas units are of the same capacity.

In an alternative embodiment said first and second hydrogas units are of different capacity.

In another embodiment the first hydrogas unit and the second hydrogas unit each have oil cylinders which are interconnected and means is provided for transferring oil between said oil cylinders of the first and second hydrogas units.

In another embodiment said first and second hydrogas units are arranged in an opposed configuration projecting outwardly at opposite sides of the support.

In a further embodiment said first and second hydrogas units are mounted in a juxtaposed position on the support. In this arrangement said first and second hydrogas units may conveniently be mounted in a substantially horizontal orientation on the support.

In another aspect the invention provides a suspension system incorporating the suspension unit or assembly of the invention as herein described.

### BRIEF DESCRIPTION OF THE DRAWINGS

The invention will be more clearly understood by the following description of some embodiments thereof, given by way of example only, with reference to the accompanying drawings, in which;

FIG. 1 is a sectional elevational view of a dual hydrogas suspension unit of the invention;

FIG. 2 is an elevational view of the hydrogas suspension unit,

FIG. 3 is a side elevational view of the hydrogas suspension unit,

FIG. 4 is a perspective view of the dual hydrogas suspension unit, shown in use,

FIG. 5 is a partially sectioned elevational view of another dual hydrogas suspension unit according to a second embodiment of the invention;

FIG. 6 is a perspective view of the hydrogas suspension unit of FIG. 5, shown in use,

FIG. 7 is a graph illustrating wheel deflection characteristics typical of the dual hydrogas suspension unit of the invention; and

FIG. 8 shows an enlarged diagram of the “upright quadrant” of the wheel deflection characteristic for the dual hydrogas suspension unit of the invention.

### DETAILED DESCRIPTION OF THE PREFERRED EMBODIMENTS

Referring to the drawings there is illustrated a dual hydrogas suspension unit or assembly according to the invention indicated generally by the reference numeral 1. It will be noted that the suspension assembly 1 provides an associated pair of hydrogas units acting in opposition to one another. The suspension assembly 1 is for mounting on a vehicle body or chassis and acts on a leading or trailing suspension arm 3 which is connected to a road wheel 4 of said vehicle in use.

The suspension assembly 1 has a support housing 6 for mounting on a vehicle. A first or upper hydrogas unit 10 and a second or lower hydrogas unit 20 which act in opposition to each other are mounted on the support housing 6. Each hydrogas unit 10, 20 has an oil cylinder 11, 21, a gas cylinder 12, 22, a damper unit 13, 23, a separator piston 14, 24, a plunger piston 15, 25 and a connecting rod 16, 26 respectively. The separator piston 14, 24 divides the gas cylinder 12, 22 into a gas chamber or volume 17, 27 and an oil chamber or volume 18, 28. The gas volume 17, 27 is charged with nitrogen or another suitable gas that acts as the spring medium. Each oil volume 18, 28 in the gas cylinder 12, 22 is separated from a further oil chamber or volume 19, 29 in the associated oil cylinder 11, 21 by the damper assembly 13, 23 which allows oil to flow through conduits 30, 31 between the associated oil volumes 18, 28 and 19, 29 with a pressure drop related to the oil flow rate. The plunger piston 15, 25 is joined by a connecting rod 16, 26 with a crankshaft 2 which is rotatably mounted in the housing 6.

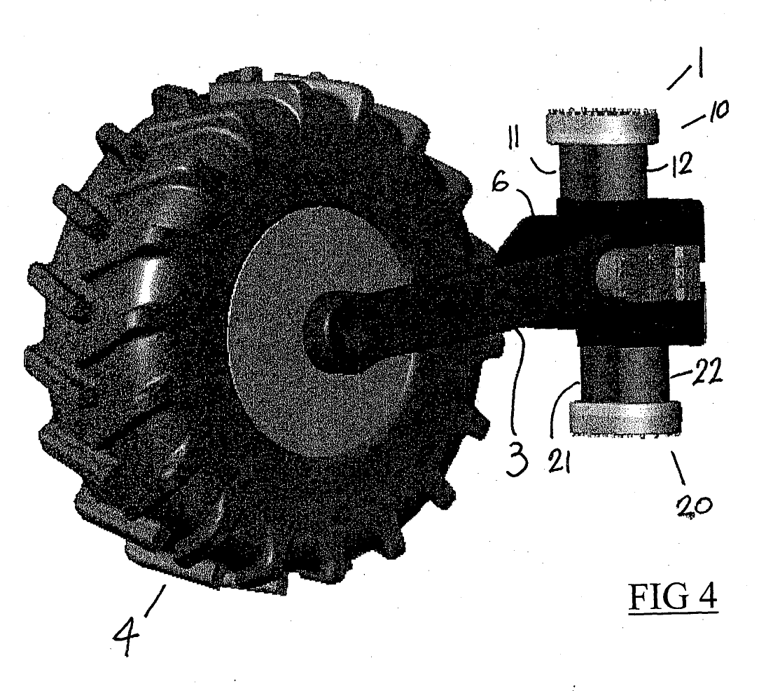

The pressures in each of the oil volumes 19, 29 acting on the plunger pistons 15, 25 exert opposing forces through the connecting rods 16, 26 on the crankshaft 2. The resultant torque on the crankshaft 2 resists suspension forces applied to a leading or trailing suspension arm shown as reference numeral 3 in FIG. 4 which is operatively connected to the crankshaft 2. Pivotal movement in use of the suspension arm 3 will rotate the crankshaft 2. Each of the connecting rods 16, 26 is connected to the crankshaft 2 such that the first hydrogas unit 10 and second hydrogas unit 20 resist rotation of the crankshaft 2 in opposite directions.

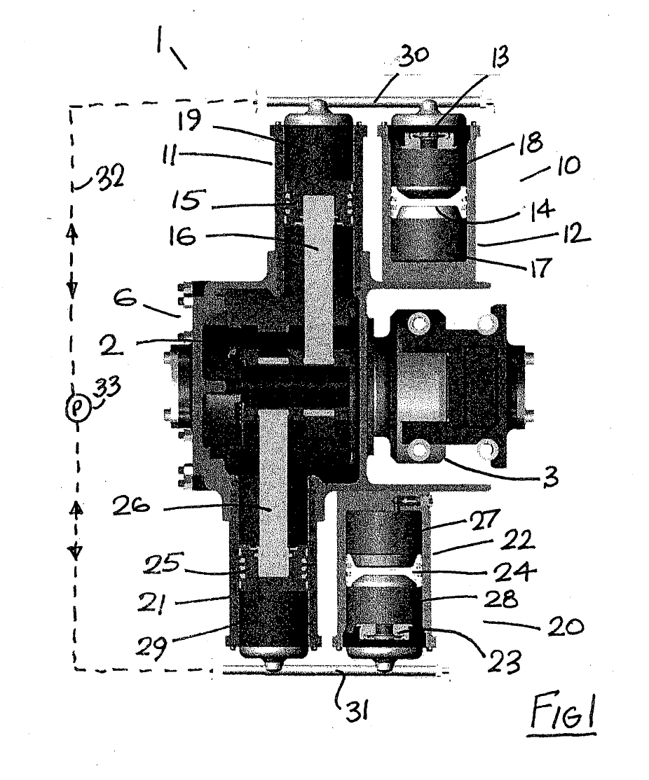

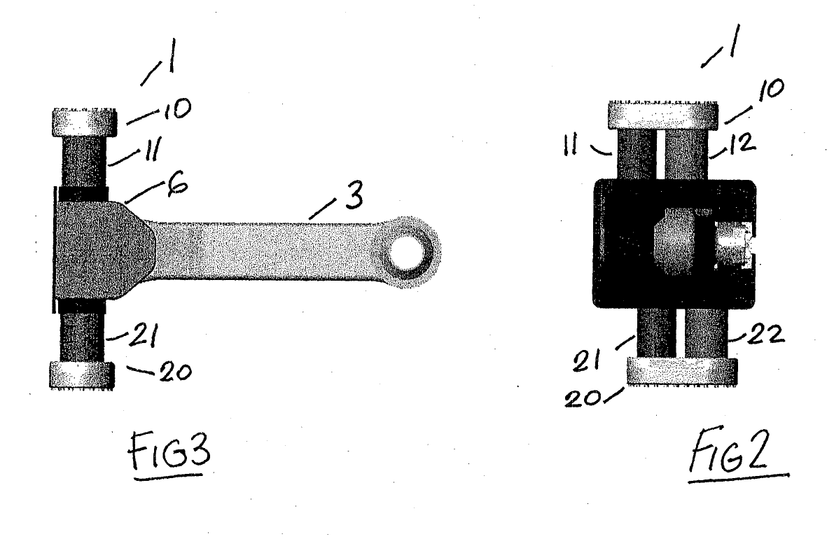

A communicating passage between oil volumes 19 and 29 (indicated in broken outline in FIG. 1) or 18 and 28 allows oil to be pumped by pump 33 from the lower hydrogas unit 20 to the upper hydrogas unit 10 or vice versa.

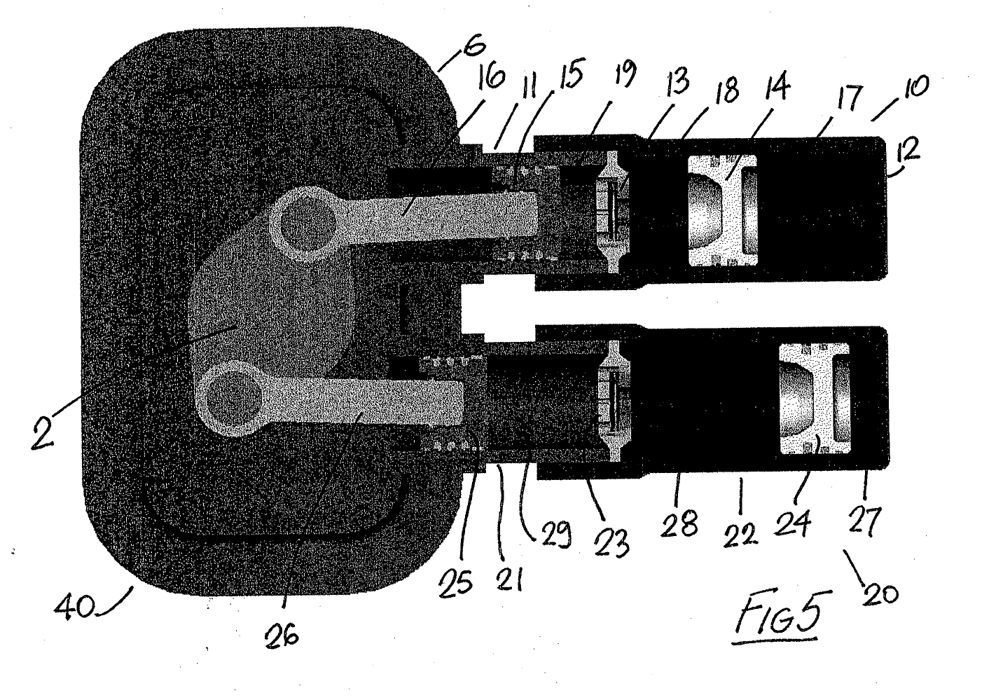

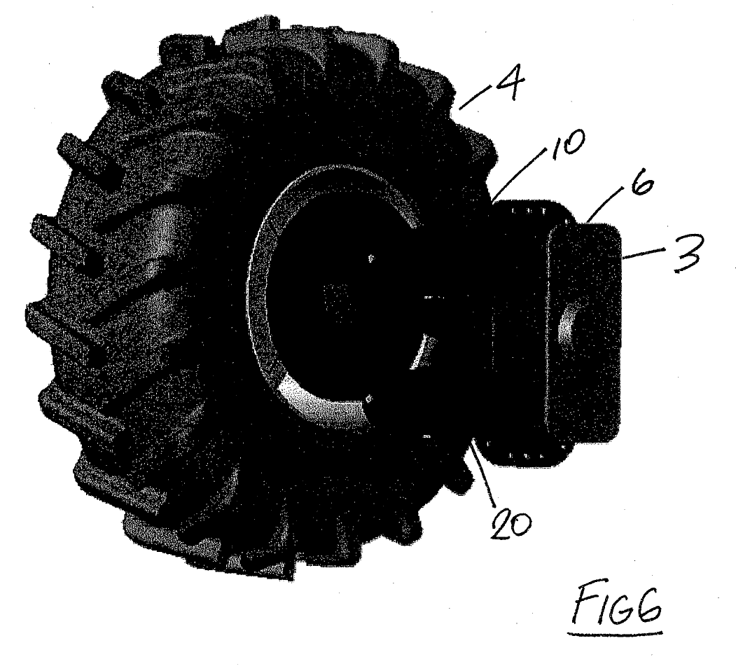

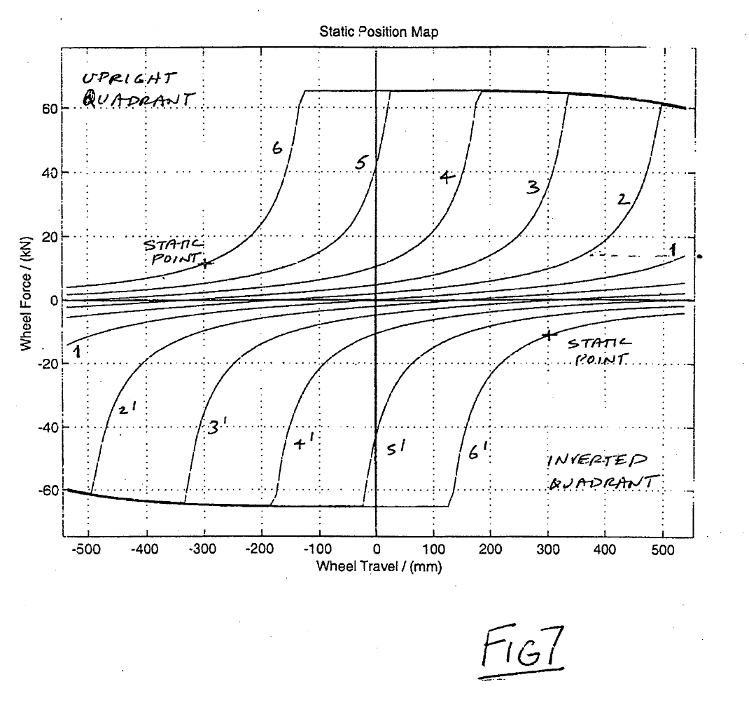

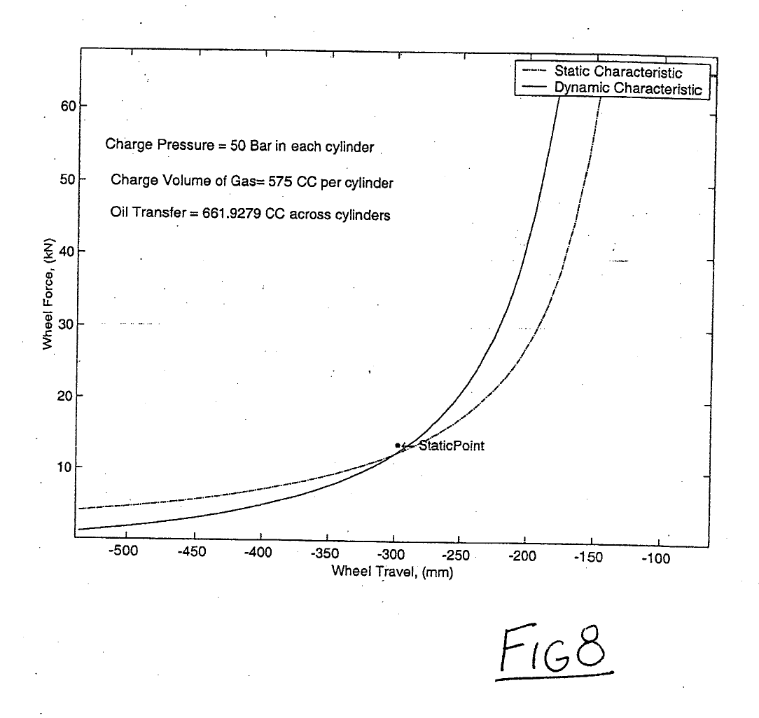

FIG. 5 shows another arrangement of dual hydrogas suspension unit, indicated generally by the reference numeral 40. Parts similar to those described previously are assigned the same reference numerals. In this case the two hydrogas units, that is the first hydrogas unit 10 and the second hydrogas unit 20 are arranged in a juxtaposed horizontal configuration with one above the other as an alternative to the opposed upright configuration of the embodiment of FIG. 1. It will be noted however that as previously described the forces applied through the connecting rods 16, 26 to the crankshaft 2 act in opposite directions. It will be appreciated that the pair of hydrogas units 10, 20 could alternatively be supported in an upright orientation or at an inclined angle to the horizontal.

Wheel deflection characteristics typical of a suspension system according to the invention are shown in FIG. 7. Characteristic 1 is for a symmetrical system in which the upper hydrogas unit 10 and lower hydrogas unit 20 are identical and are charged with identical quantities of oil and gas. Characteristics 2 to 6 are obtained by pumping incremental quantities of oil from the lower to the upper cylinder. Characteristics 2′ to 6′ are obtained by pumping incremental quantities of oil from the upper to the lower cylinder. It will be noted that the direction of pumping may be inverted if the orientation of either the crankshaft 2 or trailing arm 3 are changed in a particular embodiment of the invention.

For an invertable vehicle, the “upright quadrant” of the diagram would generally be used when the vehicle is in the upright position while the “inverted quadrant” would be used when the vehicle is inverted.

FIG. 8 shows an enlarged diagram of the “upright quadrant” of the wheel deflection characteristic. The dynamic characteristic differs from the static characteristic, as it is no longer isothermal.

It will be appreciated that the invention may be applied in many variations. A non-symmetric system may be used in which the first or upper hydrogas unit 10 and the second or lower hydrogas unit 20 are not identical. The invention may also be used in vehicles which are not required to invert, to enable load compensation or to allow the vehicle to squat. The ride height of a vehicle can be adjusted by transferring oil from one cylinder to the other which will alter the position of the trailing arm.

It will also be noted that various configurations of the hydrogas unit pistons are possible such as the opposed orientation of FIG. 1 and the juxtaposed orientation of FIG. 5. Other possibilities include a V-formation. The hydrogas unit pistons can be arranged in any desirable configuration for a particular application so long as the torques applied to the crankshaft by each of the hydrogas units act in opposite directions.

The invention is not limited to the embodiments hereinbefore described and may be varied in both construction and detail within the scope of the appended claims.

1. A hydrogas suspension unit for acting on a leading or trailing suspension arm connected between the suspension unit and a vehicle road wheel, the suspension unit including:
a support for mounting on the vehicle,
pivot means for pivotally mounting the suspension arm on the support,
a pair of associated hydrogas units mounted on the support, namely a first hydrogas unit and a second hydrogas unit,
each of said first hydrogas unit and second hydrogas unit being operably connected to the pivot means to resist pivotal movement of said pivot means in opposite directions.

2. A suspension unit as claimed in claim 1 wherein each hydrogas unit has a gas cylinder and an associated oil cylinder,
said gas cylinder having a separator piston slidably mounted therein and dividing the gas cylinder into a gas chamber and an oil chamber,
said oil cylinder having a plunger piston slidably mounted within the oil cylinder and defining therewith an oil chamber of variable volume,
the oil chamber of the oil cylinder communicating with the oil chamber of the gas cylinder via a damper which is operable to regulate the flow of oil between the oil cylinder and the gas cylinder,
the plunger piston being connected by a connecting rod to a crankshaft which forms the pivot means,
said crankshaft being rotatably mounted on the support,
said crankshaft having means for connection to the suspension arm,
the connecting rods of the first hydrogas unit and the second hydrogas unit being connected to the crankshaft such that the first hydrogas unit and the second hydrogas unit resist rotation of the crankshaft in opposite directions.

3. A suspension unit as claimed in claim 1 wherein said first and second hydrogas units are of the same capacity.

4. A suspension unit as claimed in claim 1 wherein said first and second hydrogas units are of different capacity.

5. A suspension unit as claimed in claim 1 wherein the first hydrogas unit and the second hydrogas unit each have oil cylinders which are interconnected and means is provided for transferring oil between said oil cylinders of the first and second hydrogas units.

6. A suspension unit as claimed in claim 1 wherein said first and second hydrogas units are arranged in an opposed configuration projecting outwardly at opposite sides of the support.

7. A suspension unit as claimed in claim 1 wherein said first and second hydrogas units are mounted in a juxtaposed position on the support.

8. A suspension unit as claimed in claim 7 wherein said first and second hydrogas units are mounted in a substantially horizontal orientation on the support.

9. A hydrogas suspension unit for acting on a leading or trailing suspension arm connected between the suspension unit and a vehicle road wheel, the suspension unit including:
a support for mounting on the vehicle,
pivot means for pivotally mounting the suspension arm on the support,
a pair of associated hydrogas units mounted on the support, namely a first hydrogas unit and a second hydrogas unit,
each of said first hydrogas unit and second hydrogas unit being operably connected to the pivot means to resist pivotal movement of said pivot means in opposite directions,
each hydrogas unit having a gas cylinder and an associated oil cylinder,
said gas cylinder having a separator piston slidably mounted therein and dividing the gas cylinder into a gas chamber and an oil chamber,
said oil cylinder having a plunger piston slidably mounted within the oil cylinder and defining therewith an oil chamber of variable volume,
the oil chamber of the oil cylinder communicating with the oil chamber of the gas cylinder via a damper which is operable to regulate the flow of oil between the oil cylinder and the gas cylinder,
the plunger piston being connected by a connecting rod to a crankshaft which forms the pivot means,
said crankshaft being rotatably mounted on the support,
said crankshaft having means for connection to the suspension arm,
the connecting rods of the first hydrogas unit and the second hydrogas unit being connected to the crankshaft such that the first
hydrogas unit and the second hydrogas unit resist rotation of the crankshaft in opposite directions.

10. A suspension unit as claimed in claim 9 wherein said first and second hydrogas units are of the same capacity.

11. A suspension unit as claimed in claim 9 wherein said first and second hydrogas units are of different capacity.

12. A suspension unit as claimed in claim 9 wherein the first hydrogas unit and the second hydrogas unit each have oil cylinders which are interconnected and means is provided for transferring oil between said oil cylinders of the first and second hydrogas units.

13. A suspension unit as claimed in claim 9 wherein said first and second hydrogas units are arranged in an opposed configuration projecting outwardly at opposite sides of the support.

14. A suspension unit as claimed in claim 9 wherein said first and second hydrogas units are mounted in a juxtaposed position on the support.

15. A suspension unit as claimed in claim 14 wherein said first and second hydrogas units are mounted in a substantially horizontal orientation on the support.

16. A hydrogas suspension unit for acting on a leading or trailing suspension arm connected between the suspension unit and a vehicle road wheel, the suspension unit including:
a support for mounting on the vehicle,
pivot means for pivotally mounting the suspension arm on the support,
a pair of associated hydrogas units mounted on the support, namely a
first hydrogas unit and a second hydrogas unit,
each of said first hydrogas unit and second hydrogas unit being operably connected to the pivot means to resist pivotal movement of said pivot means in opposite directions,
each hydrogas unit having a gas cylinder and an associated oil cylinder,
said gas cylinder having a separator piston slidably mounted therein and dividing the gas cylirider into a gas chamber and an oil chamber,
said oil cylinder having a plunger piston slidably mounted within the oil cylinder and defining therewith an oil chamber of variable volume,
the oil chamber of the oil cylinder communicating with the oil chamber of the gas cylinder via a damper which is operable to regulate the flow of oil between the oil cylinder and the gas cylinder,
the plunger piston being connected by a connecting rod to a crankshaft which forms the pivot means,
said crankshaft being rotatably mounted on the support,
said crankshaft having means for connection to the suspension arm,
the connecting rods of the first hydrogas unit and the second hydrogas unit being connected to the crankshaft such that the first hydrogas unit and the second hydrogas unit resist rotation of the crankshaft in opposite directions,
said first and second hydrogas units being of the same capacity,

17. A hydrogas suspension unit for acting on a leading or trailing suspension arm connected between the suspension unit and a vehicle road wheel, the suspension unit including:
a support for mounting on the vehicle,
pivot means for pivotally mounting the suspension arm on the support,
a pair of associated hydrogas units mounted on the support, namely a first hydrogas unit and a second hydrogas unit,
each of said first hydrogas unit and second hydrogas unit being operably connected to the pivot means to resist pivotal movement of said pivot means in opposite directions,
each hydrogas unit having a gas cylinder and an associated oil cylinder,
said gas cylinder having a separator piston slidably mounted therein and dividing the gas cylinder into a gas chamber and an oil chamber,
said oil cylinder having a plunger piston slidably mounted within the oil cylinder and defining therewith an oil chamber of variable volume,
the oil chamber of the oil cylinder communicating with the oil chamber of the gas cylinder via a damper which is operable to regulate the flow of oil between the oil cylinder and the gas cylinder,
the plunger piston being connected by a connecting rod to a crankshaft which forms the pivot means,
said crankshaft being rotatably mounted on the support,
said crankshaft having means for connection to the suspension arm,
the connecting rods of the first hydrogas unit and the second hydrogas unit being connected to the crankshaft such that the first hydrogas unit and the second hydrogas unit resist rotation of the crankshaft in opposite directions,
said first and second hydrogas units being of different capacity.

18. A hydrogas suspension unit for acting on a leading or trailing suspension arm connected between the suspension unit and a vehicle road wheel, the suspension unit including:
a support for mounting on the vehicle,
pivot means for pivotally mounting the suspension arm on the support,
a pair of associated hydrogas units mounted on the support, namely a first hydrogas unit and a second hydrogas unit,
each of said first hydrogas unit and second hydrogas unit being operably connected to the pivot means to resist pivotal movement of said pivot means in opposite directions,
each hydrogas unit having a gas cylinder and an associated oil cylinder,
said gas cylinder having a separator piston slidably mounted therein and dividing the gas cylinder into a gas chamber and an oil chamber,
said oil cylinder having a plunger piston slidably mounted within the oil cylinder and defining therewith an oil chamber of variable volume,
the oil chamber of the oil cylinder communicating with the oil chamber of the gas cylinder via a damper which is operable to regulate the flow of oil between the oil cylinder and the gas cylinder,
the plunger piston being connected by a connecting rod to a crankshaft which forms the pivot means,
said crankshaft being rotatably mounted on the support,
said crankshaft having means for connection to the suspension arm,
the connecting rods of the first hydrogas unit and the second hydrogas unit being connected to the crankshaft such that the first hydrogas unit and the second hydrogas unit resist rotation of the crankshaft in opposite directions,
the first hydrogas unit and the second hydrogas unit each have oil cylinders which are interconnected and means is provided for transferring oil between said oil cylinders of the first and second hydrogas units.

19. A hydrogas suspension unit for acting on a leading or trailing suspension arm connected between the suspension unit and a vehicle road wheel, the suspension unit including:
a support for mounting on the vehicle,
pivot means for pivotally mounting the suspension arm on the support,
a pair of associated hydrogas units mounted on the support, namely a first hydrogas unit and a second hydrogas unit,
each of said first hydrogas unit and second hydrogas unit being operably connected to the pivot means to resist pivotal movement of said pivot means in opposite directions,
each hydrogas unit having a gas cylinder and an associated oil cylinder,
said gas cylinder having a separator piston slidably mounted therein and dividing the gas cylinder into a gas chamber and an oil chamber,
said oil cylinder having a plunger piston slidably mounted within the oil cylinder and defining therewith an oil chamber of variable volume,
the oil chamber of the oil cylinder communicating with the oil chamber of the gas cylinder via a damper which is operable to regulate the flow of oil between the oil cylinder and the gas cylinder,
the plunger piston being connected by a connecting rod to a crankshaft which forms the pivot means,
said crankshaft being rotatably mounted on the support,
said crankshaft having means for connection to the suspension arm,
the connecting rods of the first hydrogas unit and the second hydrogas unit being connected to the crankshaft such that the first hydrogas unit and the second hydrogas unit resist rotation of the crankshaft in opposite directions,
said first and second hydrogas units being mounted in a juxtaposed position on the support.

20. A trailing arm suspension assembly for a vehicle including:
a support for mounting on the vehicle,
pivot means for pivotally mounting a suspension arm on the support,
a pair of associated hydrogas units mounted on the support, namely a first hydrogas unit and a second hydrogas unit,
each of said first hydrogas unit and second hydrogas unit being operably connected to the pivot means to resist pivotal movement of said pivot means in opposite directions,
each hydrogas unit having a gas cylinder and an associated oil cylinder,
said gas cylinder having a separator piston slidably mounted therein and dividing the gas cylinder into a gas chamber and an oil chamber,
said oil cylinder having a plunger piston slidably mounted within the oil cylinder and defining therewith an oil chamber of variable volume,
the oil chamber of the oil cylinder communicating with the oil chamber of the gas cylinder via a damper which is operable to regulate the flow of oil between the oil cylinder and the gas cylinder,
the plunger piston being connected by a connecting rod to a crankshaft which forms the pivot means,
said crankshaft being rotatably mounted on the support,
said crankshaft having means for connection to the suspension arm,
the connecting rods of the first hydrogas unit and the second hydrogas unit being connected to the crankshaft such that the first hydrogas unit and the second hydrogas unit resist rotation of the crankshaft in opposite directions,
